(19) United States
(12) Patent Application Publication
(10) Pub. No.: US 2018/0251305 A1
(43) Pub. Date: Sep. 6, 2018

(54) ROLLER MAT FOR INSTALLATION IN A FLOOR AREA OF THE FREIGHT COMPARTMENT

(71) Applicant: Airbus Operations GmbH, Hamburg (DE)

(72) Inventors: Sascha Nowarre, Hamburg (DE); Ralph Knüppel, Hamburg (DE); Uwe Panzram, Hamburg (DE); Stephan Kahle, Hamburg (DE); Thomas Wellbrock, Hamburg (DE)

(21) Appl. No.: 15/906,826

(22) Filed: Feb. 27, 2018

(30) Foreign Application Priority Data
Mar. 2, 2017 (DE) 10 2017 203 388.6

(51) Int. Cl. B65G 13/11; B64D 9/00; B65G 1/02; B65G 39/12

(52) U.S. Cl. CPC B65G 13/11; B65G 39/12; B65G 1/02; B64D 9/00

(57) ABSTRACT

A roller mat includes roller elements, an upper shell which is provided with openings for receiving the roller elements, a lower shell and a foam element which is arranged between the upper shell and the lower shell. The foam element is provided with recesses which are for receiving the roller elements and which are aligned with the openings constructed in the upper shell in the region of an upper side facing the upper shell.

### CROSS-REFERENCE TO RELATED APPLICATION

This application claims priority to German Patent Application DE 10 2017 203 388.6 filed Mar. 2, 2017, the entire disclosure of which is incorporated by reference herein.

### TECHNICAL FIELD

The subject matter herein relates to a roller mat suitable for installation in a storage compartment. The subject matter herein further relates to a storage compartment which is provided with such a roller mat and an aircraft which is provided with such a roller mat and/or such a storage compartment.

### BACKGROUND

Loads which are intended to be transported in freight or passenger aircraft are usually stored in standardized containers or on standardized pallets, so-called Unit Load Devices (ULDs). In order to be able to displace the ULDs in the storage compartment of the aircraft, roller mats and roller paths are generally integrated in a floor of the storage compartment and allow, depending on the configuration, a direction-dependent or direction-independent movement of the ULDs. Roller mats which are currently fitted in aircraft storage compartments comprise a plurality of U-shaped profiles which are orientated parallel with each other and which are fixed to an upper side of a floor plate of the storage compartment via support rails which are used to reinforce the overall construction. In the region of a surface which forms an area which is accessible on foot or in a vehicle, the U-shaped profiles are provided with recesses in order to receive roller elements which are generally constructed in the form of ball elements. Intermediate spaces which are present between the U-shaped profiles are covered by covering plates which are riveted to the U-shaped profiles. At a lower side of the storage compartment floor plate, an insulation element is fitted to the storage compartment floor plate and insulates the storage compartment floor plate against cold. Finally, there is provided between the lower side of the storage compartment floor plate and the insulation element a seal which prevents the introduction of moisture.

### SUMMARY

An object of the subject matter herein is to provide a roller mat which is suitable in particular for use in a storage compartment of an aircraft and which has a small weight and which can readily be assembled. Furthermore, an object of the subject matter herein is to provide a storage compartment which is provided with such a roller mat and an aircraft which is provided with such a roller mat and/or such a storage compartment.

A roller mat which is particularly suitable for use in a storage compartment of a transport medium, such as, for example, an aircraft, but which can also be used in a stationary storage compartment, such as, for example, a storage building, comprises a plurality of roller elements. The roller mat further comprises an upper shell which is provided with a plurality of openings for receiving the roller elements and a lower shell.

Loads can be moved by the roller elements which project out of the openings provided in the upper shell with a spacing from an upper side of the upper shell which is determined by the dimensions and the arrangement of the roller elements relative to the upper shell with low friction parallel with the upper side of the upper shell. The loads may be standardized containers or standardized pallets, that is to say, ULDs, but also any other loads. The roller elements may comprise any suitable material, for example, a metal or a plastics material. The only important aspect is that the roller elements have a mechanical ability to be loaded which is adapted to the weight and the shape of the loads which are provided for transport in a storage compartment which is provided with the roller mat. To this end, the roller elements can be configured to allow a movement of loads in all directions parallel with the upper side of the upper shell. To this end, the roller elements can be constructed, for example, in a ball-like manner. If it is sufficient to allow a movement of a load in only one direction parallel with the upper side of the upper shell, however, the roller elements can also be constructed in the form of circular-cylindrical rollers.

A foam element which is provided with a plurality of recesses which are for receiving the roller elements and which are aligned with the openings constructed in the upper shell in the region of an upper side facing the upper shell is arranged between the upper shell and the lower shell. Consequently, the roller mat has a sandwich-like construction which is distinguished by a small weight with at the same time a higher mechanical ability to be loaded. Furthermore, the roller mat can readily be pre-assembled to form an independently manipulable component and can subsequently be installed quickly and with little operational complexity in a storage compartment, in particular an aircraft storage compartment.

Similarly to the roller elements, the upper shell and the lower shell of the roller mat may also comprise any suitable material which is suitable for withstanding the mechanical loads which act on these two components of the roller mat during operation of the roller mat. Preferably, however, the upper shell and the lower shell comprise aluminum or an aluminum alloy. The lower shell and the upper shell are then sufficiently robust to protect the foam element from mechanical loads without increasing the weight of the roller mat in a disadvantageous manner.

In a preferred embodiment of the roller mat, the upper shell, the lower shell and the foam element are adhesively bonded to each other. The roller mat can then be particularly readily pre-assembled. Furthermore, fixing devices which increase the weight of the roller mat, such as, for example, screws or rivets for connecting the upper shell, the lower shell and the foam element, can be dispensed with.

The foam element of the roller mat preferably comprises a closed-cell foam material. The foam element thereby obtains fluid-repellent properties because the introduction of moisture into the foam element is prevented. In a particularly preferred embodiment of the roller mat, the foam element comprises a polyphenyl sulphone foam material. This foam material is distinguished by good mechanical properties with at the same time low weight. The foam element is thereby in a position to impart the desired rigidity and stability to the roller mat. Furthermore, polyphenyl sulphone foams are burn-through-resistant and therefore permitted for use in aircraft construction.

The upper shell preferably comprises a covering element which forms a surface which is accessible on foot or in a vehicle and which is provided with the plurality of openings for receiving the roller elements. Furthermore, the upper shell may comprise a lateral element which extends at least partially over a peripheral edge of the covering element from the covering element in the direction of the lower shell. Depending on the construction of the covering element, the lateral element may have a plurality of portions which extend over individual portions of the peripheral edge of the covering element from the covering element in the direction of the lower shell. The lower shell may comprise a base element which forms a lower side of the roller mat. A lateral element of the lower shell can extend at least partially over a peripheral edge of the base element from the base element in the direction of the upper shell. Depending on the construction of the base element, the lateral element may have a plurality of portions which extend over individual portions of the peripheral edge of the base element from the base element in the direction of the upper shell.

The lateral element of the upper shell preferably extends at least partially substantially parallel with a lateral edge of the foam element. Alternatively or additionally, the lateral element of the lower shell can also at least partially extend substantially parallel with a lateral edge of the foam element. The lateral element of the upper shell and/or the lateral element of the lower shell can then at least partially cover the lateral edge of the foam element and protect it from mechanical impairments. Furthermore, fluid is prevented or at least inhibited from being introduced into the roller mat.

Depending on the construction of the foam element, that is to say, depending on the construction of the lateral edge of the foam element, the lateral element of the upper shell and/or the lateral element of the lower shell can extend at any angle from the covering element of the upper shell or the base element of the lower shell. However, the lateral element of the upper shell preferably has at least one portion which extends substantially perpendicularly from the covering element of the upper shell in the direction of the lower shell. Similarly, the lateral element of the lower shell preferably has at least one portion which extends substantially perpendicularly from the base element of the lower shell in the direction of the upper shell.

In a particularly preferred embodiment of the roller mat, however, the lateral element of the upper shell has in the region of at least one lateral edge of the covering element a portion which extends at an angle of from 20 to 70°, in particular from 30 to 60° and particularly preferably from 40 to 50° relative to the covering element from the covering element in the direction of the lower shell. This portion of the lateral element is preferably on a support element which is provided on the lower shell and which is formed in a complementary manner, whereby an inclined approach region of the roller mat is formed. In other words, the support element which is provided on the lower shell forms an oblique plane which is covered by the portion of the lateral element of the upper shell and via which a load can be comfortably pushed onto the roller mat.

In principle, the approach region of the roller mat can also be formed only by an inclined element which is fitted to the lower shell or the upper shell. By the approach region being shaped with a support element which is provided on the lower shell and which is covered by a portion of the lateral element of the upper shell, however, the foam element of the roller mat is protected from mechanical loads particularly well. Furthermore, fluid is prevented from being introduced inside the roller mat.

Preferably, the portion of the lateral element of the upper shell, which portion extends at an angle of from 20 to 70°, in particular from 30 to 60° and particularly preferably from 40 to 50° relative to the covering element from the covering element in the direction of the lower shell, is positioned at least in an outer peripheral region of the approach region of the roller mat directly on the support element which is provided on the lower shell. In other words, at least in an outer peripheral region of the approach region of the roller mat, no foam element is provided between the portion of the lateral element of the upper shell and the support element of the lower shell. It is thereby possible to produce the small structural height of the roller mat as desired in the outer peripheral region of the approach region. In an inner peripheral region of the approach region, however, a portion of the foam element constructed with an inclined upper side can be arranged between the portion of the lateral element of the upper shell and the support element of the lower shell.

The upper shell, the lower shell and the foam element preferably have receiving members which are aligned with each other and which are configured to receive a fixing device for fixing the roller mat to a structural element of a storage compartment. The structural element of the storage compartment may be, for example, a structural floor element or another suitable structural carrier element. The fixing device may be in the form of a screw or a rivet.

In a preferred embodiment of the roller mat, the mutually aligned receiving members which are constructed in the upper shell, the lower shell and the foam element are arranged in the region of at least one lateral edge of the roller mat. The receiving member which is provided on the upper shell may comprise a, for example, semi-circular first recess which is constructed in the covering element of the upper shell in the region of the peripheral edge of the covering element and a second recess which is provided in the lateral element of the upper shell. Similarly, the receiving member which is provided on the lower shell may comprise a, for example, semi-circular first recess which is constructed in the base element of the lower shell in the region of the peripheral edge of the base element and a second recess which is provided in the lateral element of the lower shell. However, the receiving member which is provided in the foam element may be in the form of a, for example, half-cylinder-like recess which is provided in the region of the lateral edge of the foam element.

By the fixing device receiving members being arranged in the region of a lateral edge of the roller mat, a fixing device which is received in the receiving members can be used to fix two roller mats which are arranged beside each other to a structural element of a storage compartment. The assembly of a roller mat arrangement which comprises a plurality of roller mats is thereby simplified and the weight of the roller mat arrangement is reduced. Depending on requirements, the roller mat may have a plurality of groups of receiving members for fixing devices which can be arranged so as to be distributed, for example, over the lateral edge, that is to say, the periphery of the roller mat.

There can be inserted in at least one of the openings which are constructed in the upper shell a spacer element which is configured to retain the roller element which is received in the opening in a position in the opening in which the roller element projects by a desired distance over an upper side of the upper shell, that is to say, an upper side of the covering element of the upper shell. As a result of the spacer element, the roller element is fixed in a position in the opening which is constructed in the upper shell and which is increased with respect to a position of the roller element in the opening without a spacer element. It is thereby ensured that a load which slides on the roller elements is retained with a greater spacing from the upper side of the upper shell and consequently damage to the roller mat and in particular to the upper shell of the roller mat as a result of undesirable contact with the load is prevented.

The spacer element can extend around an inner periphery of the at least one opening and can project beyond the upper side of the upper shell. For example, the spacer element can be constructed in an annular manner and can extend around an inner periphery of the opening which is formed so as to be circular, oval or another shape in accordance with the shape of the roller element which is received in the opening. Preferably, corresponding spacer elements are inserted in all the openings which are constructed in the upper shell so that all the roller elements of the roller mat project beyond an upper side of the upper shell, that is to say, an upper side of the covering element of the upper shell, by a desired distance.

In a preferred embodiment of the roller mat, there is provided in the lower shell of the roller mat a drainage system which is configured to discharge fluid which accumulates in the lower shell from the roller mat. The drainage system ensures that the weight of the roller mat is not increased by fluid which accumulates in the lower shell of the roller mat. Furthermore, moisture damage, such as, for example, corrosion damage to the roller mat, is prevented as a result of the drainage system.

The drainage system may comprise a plurality of drainage ribs. The drainage ribs can extend substantially parallel with each other in order to form at least one drainage channel between mutually adjacent ribs. Furthermore, the drainage ribs can be arranged on a surface of the lower shell which faces the foam element, that is to say, on a surface of the base element of the lower shell facing the foam element. Furthermore, the drainage system may comprise at least one drainage opening which is constructed in the lower shell. In principle, the drainage opening can be constructed in the base element of the lower shell. However, an optimum discharge of fluid which accumulates in the lower shell from the roller mat is possible when the drainage opening is constructed in a region of the lateral element of the lower shell, which region adjoins a drainage channel.

Preferably, the upper shell of the roller mat is coated with an intumescent burn-through-resistant coating. Additionally or alternatively, the lower shell of the roller mat can also be coated with an intumescent burn-through-resistant coating. The burn-through safety of the roller mat is thereby further improved so that the roller mat has the necessary burn-through safety properties which are placed on a roller mat which is suitable for installation in a storage compartment of an aircraft. The intumescent burn-through-resistant coating can be, for example, a coating on the basis of epoxy resin, but also another suitable coating.

Finally, the roller mat may further comprise a seal which extends in the region of a lower side of the lower shell facing away from the foam element, that is to say, in the region of a lower side of the base element of the lower shell, which lower side faces away from the foam element, over a peripheral edge of the lower shell. The seal allows the roller mat to be fixed, in a state sealed in the region of the lower shell thereof, to a structural element of a storage compartment or another carrier element.

A storage compartment comprises an above-described roller mat. As a result of the lightweight configuration of the roller mat, a storage compartment which is provided with the roller mat has a useful load which is increased with respect to a storage compartment which is provided with a conventional roller mat. Furthermore, the complexity for the assembly of the roller mat in the storage compartment is substantially less than the complexity for assembling a conventional roller mat.

The roller mat is preferably installed in a door region of the storage compartment. In particular, the roller mat is installed in the door region of the storage compartment in such a manner that the inclined approach region of the roller mat faces the door. A load which is intended to be transported in the storage compartment can thereby be comfortably pushed onto the roller mat.

An aircraft comprises an above-described roller mat and/or an above-described storage compartment.

Preferred embodiments of the subject matter herein will now be explained in greater detail with reference to the appended schematic drawings, in which:

### BRIEF DESCRIPTION OF THE DRAWINGS

FIG. 1 is an exploded illustration of a roller mat which is suitable for installation in a storage compartment, in particular an aircraft storage compartment; and

FIG. 2 shows a storage compartment which is provided with a roller mat according to FIG. 1.

### DETAILED DESCRIPTION

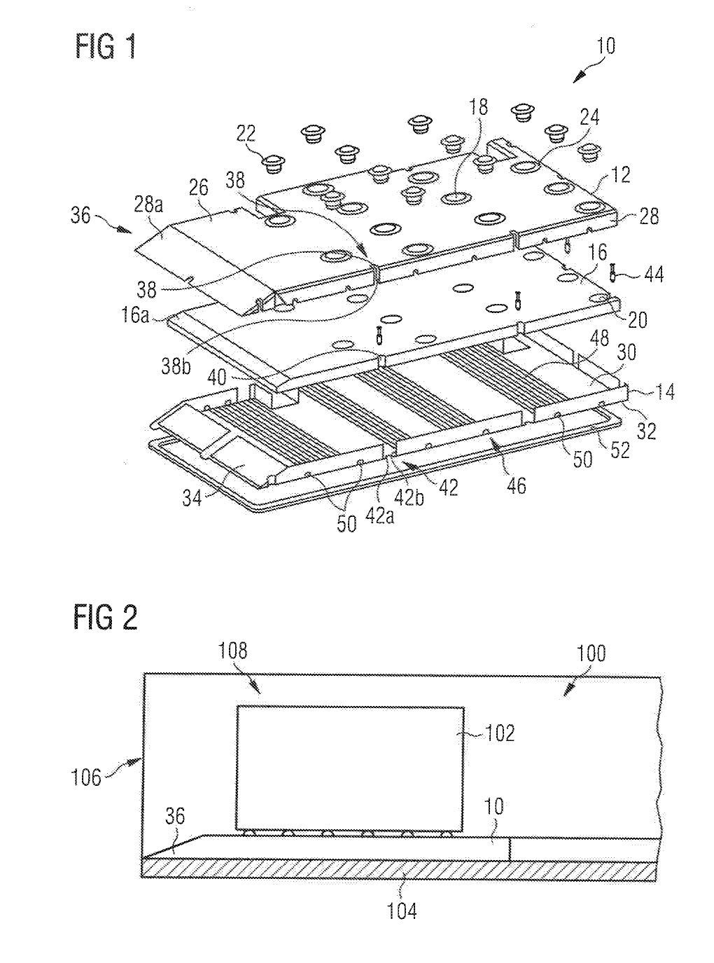

FIG. 1 shows a roller mat 10 which is particularly suitable for use in a storage compartment 100 of an aircraft as illustrated in FIG. 2, but which can also be used in a stationary storage compartment, such as, for example, a storage building. The roller mat 10 comprises an upper shell 12, a lower shell 14 and a foam element 16 which is arranged between the upper shell 12 and the lower shell 14. The upper shell 12 and the lower shell 14 each comprise aluminum or an aluminum alloy and are coated with an intumescent burn-through-resistant coating. However, the foam element 16 comprises a closed-cell foam material which is therefore fluid-repellent, in particular a burn-through-resistant polyphenyl sulphone foam material. The upper shell 12, the lower shell 14 and the foam element 16 are adhesively bonded to each other and therefore form a lightweight, independently manipulable sandwich-like component which can readily be installed with few operating steps in the storage compartment 100.

The upper shell is provided with a plurality of openings 18. The foam element 16 has in the region of an upper side facing the upper shell 12 a plurality of recesses 20 which are aligned with openings 18 which are formed in the upper shell 12. Ball-shaped roller elements 22 are arranged in the openings 18 formed in the upper shell 12 and the recesses 20 provided in the foam element 16, respectively.

A load 102 (see FIG. 2) can, by the roller elements 22 which project out of the openings 18 which are provided in the upper shell 12, be moved from an upper side of the upper shell 12 in a low-friction manner parallel with the upper side of the upper shell 12 with a spacing which is determined by the dimensions and the arrangement of the roller elements 22 relative to the upper shell 12. Since the roller elements 22 are ball-shaped, the load 102 can be moved in a state carried by the roller element 22 in all directions parallel with the upper side of the upper shell 12.

There is inserted in each of the circular openings 18 formed in the upper shell 12 a spacer element 24 which is configured to fix the roller element 22 which is received in the opening 18 in a position in the opening 18 in which the roller element 22 projects beyond the upper side of the upper shell 12 by a desired distance. Each spacer element 24 is constructed to be circular, extends around an inner periphery of the opening 18 and projects beyond the upper side of the upper shell 12. As a result of the spacer elements 24, the roller elements 22 are fixed in a position in the openings 18 which are formed in the upper shell 12 and which is raised relative to a position of the roller elements 22 in the openings 18 without spacer elements 24. It is thereby ensured that a load 102 which slides on the roller elements 22 is retained with greater spacing from the upper side of the upper shell 12 and consequently damage to the roller mat 10 and in particular the upper shell 12 of the roller mat 10 by undesirable contact with the load 102 is avoided.

The upper shell 12 comprises a covering element 26 which forms a surface which is accessible on foot or in a vehicle and which is provided with the plurality of openings 18 for receiving the roller elements 22 and a lateral element 28 which extends at least partially over a peripheral edge of the covering element 26 from the covering element 26 in the direction of the lower shell 14. Similarly, the lower shell 14 comprises a base element 30 which forms a lower side of the roller mat 10 and a lateral element 32 which extends at least partially over a peripheral edge of the base element 30 from the base element 30 in the direction of the upper shell 12.

The lateral element 28 of the upper shell 12 extends along three lateral edges of the upper shell 12 substantially perpendicularly to the covering element 26 from the covering element 26 in the direction of the lower shell 14 and parallel with corresponding lateral edges of the foam element 16. Similarly, the lateral element 32 of the lower shell 14 extends along three lateral edges of the lower shell 14 substantially perpendicularly to the base element 30 from the base element 30 in the direction of the upper shell 12 and parallel with corresponding lateral edges of the foam element 16 and the lateral element 28 of the upper shell 12. In other words, the lateral elements 28, 32 of the upper shell 12 and the lower shell 14 extend along three lateral edges of the foam element 16 and cover these lateral edges so that the foam element 16 is protected from mechanical impairments and the introduction of fluid into the roller mat 10 is prevented or at least made more difficult.

In the region of a lateral edge of the covering element 26, however, the lateral element 28 of the upper shell 12 has a portion 28a which extends in the embodiment of a roller mat 10 shown in FIG. 1 at an angle of approximately 70° relative to the covering element 26 from the covering element 26 in the direction of the lower shell 14. This portion 28a of the lateral element 28 is positioned on a support element 34 which is formed in a complementary manner and which is provided on the lower shell 14. An inclined approach region 36 of the roller mat 10 is thereby formed, via which region 36 a load 102 can comfortably be pushed onto the roller mat 10.

In an outer peripheral region of the approach region 36 of the roller mat 10, the portion 28a of the lateral element 28 of the upper shell 12 is positioned directly on the support element which is provided on the lower shell 14, which portion 28a extends from the covering element 26 in the direction of the lower shell 14 at an angle of approximately 70° relative to the covering element 26, that is to say, no foam element 16 is provided in the outer peripheral region of the approach region 36 between the portion 28a of the lateral element 28 of the upper shell 12 and the support element 34 of the lower shell 14. It is thereby possible to produce a small structural height of the roller mat 10 in the outer peripheral region of the approach region 36. However, a portion 16a of the foam element 16 formed so as to have an inclined upper side is arranged in an inner peripheral region of the approach region 36 between the portion 28a of the lateral element 26 of the upper shell 12 and the support element 34 of the lower shell 14.

The upper shell 12, the lower shell 14 and the foam element 16 have a plurality of groups of mutually aligned receiving members 38, 40, 42 which are each configured to receive a fixing device 44 for fixing the roller mat 10 to a structural element 104 of the storage compartment 100 (see FIG. 2). The aligned receiving members 38, 40, 42 are arranged in the region of the three lateral edges of the roller mat 10, in which additional roller mats 10 are fitted in the storage compartment 100 adjacent to the roller mat 10. A fixing device 44 for fixing two roller mats 10 which are arranged beside each other to the structural element 104 of the storage compartment 100 can thereby be used.

The receiving member 38 which is provided on the upper shell 12 comprises a semi-circular first recess 38a which is formed in the covering element 26 of the upper shell 12 in the region of the peripheral edge of the covering element 26 and a second recess 38b which is provided in the lateral element 28 of the upper shell 12. Similarly, the receiving member 42 which is provided on the lower shell 14 comprises a semi-circular first recess 42a which is formed in the base element 30 of the lower shell 14 in the region of the peripheral edge of the base element 14 and a second recess 42b which is provided in the lateral element 32 of the lower shell 14. However, the receiving member 40 which is provided in the foam element 16 is constructed in the form of a semi-circular recess which is provided in the region of the lateral edge of the foam element 16.

The roller mat 10 further comprises a drainage system 46 which is provided in the lower shell 14 of the roller mat 10. The drainage system 46 is configured to discharge fluid which accumulates in the lower shell 14 from the roller mat 10 and comprises a plurality of drainage ribs 48 which are arranged on a surface of the lower shell 14 facing the foam element 16, that is to say, on a surface of the base element 30 of the lower shell 14, which surface faces the foam element 16, and which extend substantially parallel with each other in order to form at least one drainage channel between mutually adjacent ribs 48. The drainage system 46 further comprises a plurality of drainage openings 50 which are each formed in a region of the lateral element 32 of the lower shell 14 adjacent to a drainage channel or a plurality of drainage channels.

Finally, the roller mat 10 comprises a seal 52 which extends along a peripheral edge of the lower shell 14 in the region of a lower side of the lower shell 14 facing away from the foam element 16, that is to say, in the region of a lower side of the base element 30 of the lower shell 14 facing away from the foam element 16. The seal 52 allows the roller mat 10 to be secured to the structural element 104 storage compartment 100 so as to be sealed in the region of the lower shell 15 thereof.

The aircraft storage compartment 100 illustrated in FIG. 2 comprises a plurality of above-described roller mats 10 which are each installed adjacent to a door 106 of the storage compartment 100, that is to say, in a door region 108 of the storage compartment 100. In particular, the roller mats 10 are installed in the door region 108 of the storage compartment 100 in such a manner that the inclined approach region 36 of the roller mats 10 faces the door 106 of the storage compartment 100. It is thereby possible to push a load 102 which is intended to be transported in the storage compartment 100 onto the roller mats 10 in a comfortable manner.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A roller mat comprising:
a plurality of roller elements;
an upper shell comprising a plurality of openings for receiving the roller elements;
a lower shell; and
a foam element arranged between the upper shell and the lower shell and comprising a plurality of recesses which are for receiving the roller elements and which are aligned with the openings constructed in the upper shell in a region of an upper side facing the upper shell.

2. The roller mat according to claim 1, wherein the upper shell, the lower shell and the foam element are adhesively bonded to each other.

3. The roller mat according to claim 1, wherein the foam element comprises a closed-cell foam material, or a polyphenyl sulphone closed-cell foam material.

4. The roller mat according to claim 1, wherein the upper shell comprises a covering element which forms a surface which is accessible on foot or in a vehicle and comprising the openings for receiving the roller elements and a lateral element which extends at least partially over a peripheral edge of the covering element from the covering element in a direction of the lower shell, and/or wherein the lower shell comprises a base element which forms a lower side of the roller mat and a lateral element which extends at least partially over a peripheral edge of the base element from the base element in a direction of the upper shell, wherein the lateral element of the upper shell and/or the lateral element of the lower shell preferably extend(s) at least partially substantially parallel with a lateral edge of the foam element.

5. The roller mat according to claim 4, wherein the lateral element of the upper shell has in a region of at least one lateral edge of the covering element a portion which extends at an angle of from 20 to 70° relative to the covering element from the covering element in the direction of the lower shell and is positioned on a support element which is on the lower shell and which is formed in a complementary manner in order to form an inclined approach region of the roller mat.

6. The roller mat according to claim 5, wherein the portion of the lateral element of the upper shell, which portion extends at an angle of from 20 to 70° relative to the covering element from the covering element in the direction of the lower shell, is positioned at least in an outer peripheral region of the approach region of the roller mat directly on the support element which is provided on the lower shell.

7. The roller mat according to claim 1,
wherein the upper shell, the lower shell and the foam element have receiving members which are aligned with each other and which are configured to receive a fixing device for fixing the roller mat to a structural element of a storage compartment.

8. The roller mat according to claim 7, wherein the receiving members which are constructed in the upper shell, the lower shell and the foam element are arranged in the region of at least one lateral edge of the roller mat.

9. The roller mat according to claim 1,
wherein there is inserted in at least one of the openings which are constructed in the upper shell a spacer element which is configured to retain the roller element which is received in the opening in a position in the opening in which the roller element projects by a desired distance over an upper side of the upper shell, wherein the spacer element extends around an inner periphery of the at least one opening and projects beyond the upper side of the upper shell.

10. The roller mat according to claim 1,
comprising in the lower shell a drainage system which is configured to discharge fluid which accumulates the lower shell from the roller mat.

11. The roller mat according to claim 10, wherein the drainage system comprises:
a plurality of drainage ribs which extend substantially parallel with each other and/or which are arranged on a surface of the lower shell which faces the foam element; and/or
at least one drainage opening which is constructed in the lower shell, in particular in the lateral element of the lower shell.

12. The roller mat according to claim 1, wherein the lower shell and/or the upper shell is/are coated with an intumescent burn-through-resistant coating.

13. The roller mat according to claim 1,
wherein the roller mat further comprises a seal which extends in the region of a lower side of the lower shell facing away from the foam element over a peripheral edge of the lower shell.

14. A storage compartment having a roller mat according to claim 1, wherein the roller mat is installed in a door region of the storage compartment.

15. An aircraft which comprises a roller mat the roller mat comprising:
a plurality of roller elements;
an upper shell comprising a plurality of openings for receiving the roller elements;
a lower shell; and
a foam element arranged between the upper shell and the lower shell and comprising a plurality of recesses which are for receiving the roller elements and which are aligned with the openings constructed in the upper shell in a region of an upper side facing the upper shell.

16. The aircraft according to claim 15, further comprising a storage compartment that comprises the roller mat and wherein the roller mat is installed in a door region of the storage compartment.

17. An aircraft which comprises a storage compartment, the storage compartment comprising a roller mat, and the roller mat comprising:
a plurality of roller elements;
an upper shell comprising a plurality of openings for receiving the roller elements;
a lower shell; and
a foam element arranged between the upper shell and the lower shell and comprising a plurality of recesses which are for receiving the roller elements and which are aligned with the openings constructed in the upper shell in a region of an upper side facing the upper shell,
wherein the roller mat is installed in a door region of the storage compartment.
